(19) United States
(12) Patent Application Publication
(10) Pub. No.: US 2026/0268902 A1
(43) Pub. Date: Sep. 10, 2026

(54) METHOD FOR DIALOGUE PROCESSING, ELECTRONIC DEVICE, AND STORAGE MEDIUM

(71) Applicant: MASHANG CONSUMER FINANCE CO., LTD., Chongqing (CN)

(72) Inventor: Yue FENG, Chongqing (CN)

(21) Appl. No.: 19/327,102

(22) Filed: Sep. 12, 2025

(30) Foreign Application Priority Data
Mar. 5, 2025 (CN) 202510263170.7

(51) Int. Cl. G10L 15/22; G10L 25/57; G10L 25/63

(52) U.S. Cl. CPC G10L 15/22; G10L 25/57; G10L 25/63; G10L 2015/227

(57) ABSTRACT

A method and apparatus for dialogue processing includes: the dialogue prediction processing is performed on first input information to obtain a first reply text for the first input information; based on a second reply text that has been generated for second input information, a first parameter value for representing coherence between the first reply text and the second reply text is determined, where the second reply text is a reply text obtained by performing dialogue prediction processing on the second input information; and the adjustment processing is performed on the first reply text and the second reply text based on the first parameter value to obtain a third reply text for replying to the second input information and the first input information.

### CROSS-REFERENCE TO RELATED APPLICATION

This application claims the benefit of priority of Chinese Patent Application No. 202510263170.7, filed on Mar. 5, 2025, the contents of which are incorporated herein by reference in its entirety for all purposes.

### BACKGROUND

In the digital age, human-computer interaction has become an indispensable part of daily life and work. With the development of the artificial intelligence technology, a dialogue system (such as a chatbot or a speech assistant) has gradually become an important tool for a user to obtain information, solve problems and have entertainment. However, in the implementation of the traditional dialogue system, an effect of the real-time interaction is poor, and the coherence of dialogues is low.

### SUMMARY

Embodiments of the present disclosure provide a method for dialogue processing, an electronic device, and a storage medium.

The technical solutions in the embodiments of the present disclosure are implemented as follows.

An embodiment of the present disclosure provides a method for dialogue processing, including following operations. Dialogue prediction processing is performed on first input information to obtain a first reply text for the first input information. Based on a second reply text that has been generated for second input information, a first parameter value for representing coherence between the first reply text and the second reply text is determined, where the second reply text is a reply text obtained by performing dialogue prediction processing on the second input information. Adjustment processing is performed on the first reply text and the second reply text based on the first parameter value to obtain a third reply text for replying to the second input information and the first input information.

An embodiment of the present disclosure provides an apparatus for dialogue processing, including a dialogue prediction module, a coherence determination module and a reply text determination module.

The dialogue prediction module is configured to perform dialogue prediction processing on first input information to obtain a first reply text for the first input information.

The coherence determination module is configured to: determine, based on a second reply text that has been generated for second input information, a first parameter value for representing coherence between the first reply text and the second reply text, where the second reply text is a reply text obtained by performing dialogue prediction processing on the second input information.

The reply text determination module is configured to perform adjustment processing on the first reply text and the second reply text based on the first parameter value to obtain a third reply text for replying to the second input information and the first input information.

An embodiment of the present disclosure provides an electronic device including a memory and a processor. The memory is configured to store computer-executable instructions or computer programs. The processor is configured to execute the computer-executable instructions or computer programs stored in the memory to implement operations of: performing dialogue prediction processing on first input information to obtain a first reply text for the first input information; determining, based on a second reply text that has been generated for second input information, a first parameter value for representing coherence between the first reply text and the second reply text, where the second reply text is a reply text obtained by performing dialogue prediction processing on the second input information; and performing adjustment processing on the first reply text and the second reply text based on the first parameter value to obtain a third reply text for replying to the second input information and the first input information.

An embodiment of the present disclosure provides a non-transitory computer-readable storage medium having stored thereon computer programs or computer-executable instructions that, when executed by a processor, cause the processor to implement operations of: performing dialogue prediction processing on first input information to obtain a first reply text for the first input information; determining, based on a second reply text that has been generated for second input information, a first parameter value for representing coherence between the first reply text and the second reply text, where the second reply text is a reply text obtained by performing dialogue prediction processing on the second input information; and performing adjustment processing on the first reply text and the second reply text based on the first parameter value to obtain a third reply text for replying to the second input information and the first input information.

### BRIEF DESCRIPTION OF THE DRAWINGS

FIG. 1 is a schematic diagram of architecture of a system for dialogue processing according to an embodiment of the present disclosure.

FIG. 2 is a schematic structural diagram of an electronic device according to an embodiment of the present disclosure.

FIG. 3 is a first schematic flowchart of a method for dialogue processing according to an embodiment of the present disclosure.

FIG. 4 is a second schematic flowchart of a method for dialogue processing according to an embodiment of the present disclosure.

FIG. 5 is a third schematic flowchart of a method for dialogue processing according to an embodiment of the present disclosure.

FIG. 6 is a fourth schematic flowchart of a method for dialogue processing according to an embodiment of the present disclosure.

FIG. 7 is a schematic structural diagram of a multi-modal dialogue large model apparatus according to an embodiment of the present disclosure;

FIG. 8 is a schematic structural diagram of an input acquisition module according to an embodiment of the present disclosure.

FIG. 9 is a schematic structural diagram of a global variable manager according to an embodiment of the present disclosure.

FIG. 10 is a processing flowchart of an expert model group module according to an embodiment of the present disclosure.

FIG. 11 is a schematic diagram of an input flow of a dialogue large language model module according to an embodiment of the present disclosure;

FIG. 12 is a schematic diagram of output processing of an output presenter module according to an embodiment of the present disclosure.

FIG. 13 is a schematic diagram of an output control flow of an output presenter module according to an embodiment of the present disclosure.

FIG. 14 is a schematic flowchart of multiple dialogue large language models (LLM) according to an embodiment of the present disclosure.

### DETAILED DESCRIPTION

To make the objectives, technical solutions, and advantages of the present disclosure clearer, the present disclosure will be described in further detail below with reference to the drawings. The described embodiments should not be regarded as limiting the present disclosure. All other embodiments that are obtained by those of ordinary skill in the art without involving inventive skill fall within the scope of protection of the present disclosure.

When the following description refers to “some embodiments”, the phrasing describes a subset of all possible embodiments, but it can be understood that “some embodiments” may be the same subset or different subsets of all possible embodiments, and may be combined with each other without conflict.

The term “first\second\third” as referred to in the following description is only to distinguish similar objects, and does not represent a specific ordering of objects. It can be understood that the specific order or sequential order of “first\second\third” may be interchanged if allowed, so that the embodiments of the present disclosure described herein can be implemented in an order other than those illustrated or described herein.

In the embodiments of the present disclosure, the term “module” or “unit” refers to a computer program or a part of a computer program that has a predetermined function, works together with other related parts to achieve a predetermined objective, and may be implemented in whole or in part by using software, hardware (such as a processing circuit or a memory), or a combination thereof. Similarly, one processor (or a plurality of processors or memories) may be used to implement one or more modules or units. Furthermore, each module or unit may be a part of an integral module or unit that includes the functionality of the module or unit.

Unless otherwise defined, all technical and scientific terms used in the embodiments of the present disclosure have the same meanings as commonly understood by a person of ordinary skill in the technical field to which the present disclosure belongs. The terms used in the embodiments of the present disclosure are only for the purpose of describing the embodiments of the present disclosure, and are not intended to limit the present disclosure.

In the embodiments of the present disclosure, the relevant data collection processing, when applied to examples, should strictly obtain informed consent or separate consent for the personal information subject according to the requirements of relevant laws and regulations, and carry out subsequent data use and processing within the scope of the laws and regulations and the authorization of the personal information subject.

Before the embodiments of the present disclosure are further described in detail, the nouns and terms referred to in the embodiments of the present disclosure are illustrated. The nouns and terms referred to in the embodiments of the present disclosure are applicable to the following explanations.

1) The half-duplex communication is a manner of data transmission where information may be transmitted in two directions, but not transmitted simultaneously in two directions. The sending and reception are required to be alternated, such as in a walkie-talkie.

2) The full-duplex communication is a manner of data transmission where the information may be transmitted simultaneously in two directions, and a sender may send the data while a receiver receives the data, such as, a telephone call and modern network communication.

3) A dialogue large model is an artificial intelligence model specifically designed for processing and generating natural language dialogues. The large dialogue large model is trained with a large amount of dialogue data and is able to understand context, generate coherent responses, and simulate the manner of human conversation.

4) A text large model is a large language model trained by using deep learning technology, and is able to understand and generate the natural language text. The text large model is usually based on the architecture such as the transformer model, and has billions to tens of billions of parameters. The text large model may be applied to various tasks, including, text generation, translation, question and answer (Q&A), emotion analysis, etc.

5) A multi-modal large model is an artificial intelligence model and is able to process and generate multiple types of data (such as the text, the image, the audio, etc.). By integrating information in different modals, more complex and diverse tasks may be implemented, such as image description generation, video understanding, cross-modal retrieval, etc.

6) An expert model refers to an artificial intelligence model that has been specially designed and trained to focus on a certain task or field. Compared with the general model, the expert model usually performs better in a certain application scenario. The expert model is able to better understand and process tasks related to a field by being trained using data from the field. The advantages of the expert model lie in high efficiency and accuracy, and the expert model is applicable to applications where in-depth knowledge is required, such as the medical diagnosis, the financial analysis, the legal text processing, etc.

7) A modifier refers to a function or a processing flow where an input value is accepted, then the input value is converted according to a set rule or a conversion logic, and finally a modified value is outputted. For example, a modifier accepts a numerical variable between 0 and 1, and converts the numerical variable into a corresponding text description according to a range where the numerical variable is located.

8) A cut-off, also known as a boundary, is used for determining how to classify and process data. In the embodiments of the present disclosure, the cut-off is used for defining different intervals of emotion, and each interval is defined by a minimum value and a maximum value, and is used for enumerating the degree of emotion. For example, an interval of 0-0.25 means “very sad”, an interval of 0.25-0.45 means “a little bit sad”, and so on.

9) A slot filling method refers to a conversion method that inserts data into a predefined template or format. A slot is a placeholder in the template and is used for being filled with data. For example, “My emotion [x]” is a template where [x] is the slot, and a text “a little bit happy” is filled into the slot [x].

The dialogue large model is a dialogue device that simulates the human conversation mode. The dialogue large model is mainly classified into a general dialogue large model and a specialized dialogue large model. The general dialogue large model is an artificial intelligence model able to process a wide range of dialogue tasks and process various types of dialogues, from small talk to complex questions and answers; and the specialized dialogue large model is a dialogue large model that is optimized for a specific task or field and is trained by using specialized data, so as to provide higher accuracy and efficiency in specific applications.

The general dialogue large model adopts the half-duplex communication mode. In the general dialogue large model, a while loop is entered to wait for a user input; when it is detected that the user input is not null, the loop is exited, and the input and the full-text information in the cache are sent to the dialogue large model; the large dialogue large model generates feedback results, throws the feedback results in sequence until the ending, and sends an end mark ([end]); a displayer receives the feedback results and displays the feedback results until displaying a terminator, and the display is ended; the full-text information is stored into the cache; and a next while loop is entered to wait for another user input. The general dialogue large model has a passive service form and is unable to actively initiate a dialogue; and has a poor emotion perception capability, has plain text as the input and thus unable to effectively perceive the emotion of an interlocutor. The general dialogue large model has a long delay, a long waiting duration, and poor experience, for example, a longest waiting duration exceeds 60 s depending on the length of the answer text.

Based on the problems in the related art, the embodiments of the present disclosure provide a method and apparatus for dialogue processing, an electronic device, a computer-readable storage medium, and a computer program product, which can improve the coherence and fluency of the real-time dialogues. In the method for dialogue processing according to the embodiments of the present disclosure, firstly, dialogue prediction processing is performed on first input information to obtain a first reply text for the first input information. Then, based on a second reply text that has been generated for second input information, a first parameter value for representing coherence between the first reply text and the second reply text is determined, where the second reply text is a reply text obtained by performing dialogue prediction processing on the second input information. Finally, the adjustment processing is performed on the first reply text and the second reply text based on the first parameter value, to obtain a third reply text for replying to the second input information and the first input information.

An exemplary application of an apparatus for dialogue processing provided by the embodiments of the present disclosure will be described below, and the apparatus for dialogue processing is an electronic device configured to implement a method for dialogue processing. The electronic device provided by the embodiments of the present disclosure may be implemented as various types of terminals, such as, a notebook computer, a tablet computer, a desktop computer, a set-top box, a smartphone, a smart speaker, a smart watch, a smart TV, and an in-vehicle terminal, or may be implemented as a server. Herein, the server may be an independent physical server, a server cluster or a distributed system composed of multiple physical servers, or may be a cloud server that provides basic cloud computing services, such as, cloud services, cloud databases, cloud computing, cloud functions, cloud storage, network services, cloud communications, middleware services, domain name services, security services, Content Delivery Network (CDN), and big data and artificial intelligence platforms. The terminal may be directly or indirectly connected with the server in a manner of wired or wireless communication, which is not limited in the embodiment of the present disclosure. Hereinafter, an exemplary application when the apparatus for dialogue processing is implemented as a terminal or a server will be described.

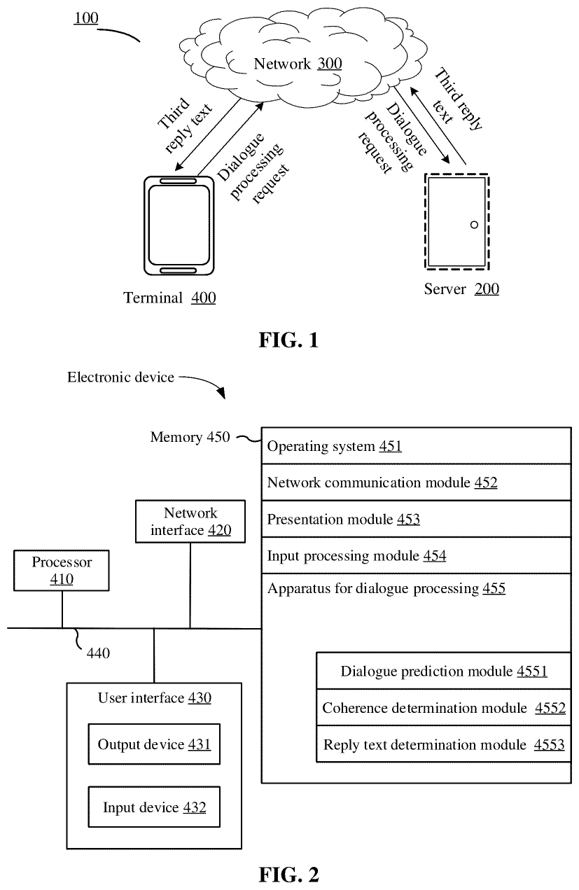

With reference to FIG. 1, FIG. 1 is a schematic diagram of architecture of a system for dialogue processing according to an embodiment of the present disclosure. In order to perform dialogue processing operations, a dialogue processing application may be provided. For example, the dialogue processing application may be an application dedicated to the dialogue processing, or may be a functional module in other applications (such as a dialogue processing module in a game application, etc.). The system 100 for dialogue processing according to the embodiments of the present disclosure includes at least a terminal 400, a network 300, and a server 200. The server 200 is a server of the dialogue processing application. The server 200 may constitute the apparatus for dialogue processing according to the embodiments of the present disclosure. That is to say, the method for dialogue processing according to the embodiments of the present disclosure is implemented through the server 200. The terminal 400 is connected to the server 200 through the network 300, and the network 300 may be a wide area network or a local area network, or a combination of both.

With reference to FIG. 1, input information of a user is acquired, through the terminal 400, in real time at a client of the dialogue processing application; after second input information is acquired, the client sends the second input information to the server 200 through the network 300; the server 200 stores the second input information in a storage space, and performs the dialogue processing on the second input information in the storage space to obtain a second reply text; and during the process of performing the dialogue processing on the second input information of the user in the storage space, first input information is acquired through the terminal 400 at the client of the dialogue processing application, and the first input information is sent to the server 200; and the server 200 stores the first input information in the storage space; the server 200 performs the dialogue prediction processing on the first input information in the storage space, obtains a first reply text for the first input information, and stores the first reply text in the storage space; the server 200 determines a first parameter value for representing coherence between the first reply text and the second reply text based on the first reply text in the storage space and the second reply text for the second input information in the storage space, herein the second reply text is a reply text obtained by performing dialogue prediction processing on the second input information; and the server 200 performs adjustment processing on the first reply text and the second reply text based on the first parameter value, and obtains a third reply text for replying to the second input information and the first input information. The server 200 may send the third reply text to the terminal 400. The terminal 400 displays the third reply text on a current interface.

In some embodiments, the terminal 400 may also perform the method for dialogue processing in the embodiment of the present disclosure. That is to say, the input information of the user is acquired, through the terminal 400, in real time at the client of the dialogue processing application; the terminal 400 stores the second input information in a storage space, and performs dialogue processing on the second input information in the storage space to obtain the second reply text; and during the process of performing the dialogue processing on the second input information of the user in the storage space, first input information is acquired through the terminal 400 at the client of the dialogue processing application, and the first input information is stored in the storage space; the terminal 400 performs the dialogue prediction processing on the first input information in the storage space, obtains the first reply text for the first input information, and stores the first reply text in the storage space; the terminal 400 determines the first parameter value for representing coherence between the first reply text and the second reply text based on the first reply text in the storage space and the second reply text for the second input information in the storage space, herein the second reply text is the reply text obtained by performing dialogue prediction processing on the second input information; and the terminal 400 performs the adjustment processing on the first reply text and the second reply text based on the first parameter value, and obtains the third reply text for replying to the second input information and the first input information. The terminal 400 displays the third reply text on the current interface.

In the scenarios of the smart home, through the combination of a camera and a speech assistant, it is possible to initiatively detect the requirements of the user and initiate dialogues, thereby providing help and suggestions in time. The camera in the smart home system may periodically acquire video footage (i.e., input information) of activities of the user at home. During the process of performing the dialogue processing on the first video footage (i.e., the second input information) of the user in the storage space, the camera acquires a second video footage (i.e., the first input information) of the user and stores the second video footage in the storage space. The dialogue prediction processing is performed on the second video footage in the storage space to obtain a first reply text for the second video footage, and the first reply text is stored in the storage space. A first parameter value for representing coherence between the first reply text and the second reply text is determined based on the first reply text in the storage space and the second reply text for the first video footage in the storage space. The second reply text is a reply text obtained by performing the dialogue prediction processing on the first video footage. The adjustment processing is performed on the first reply text and the second reply text based on the first parameter value, to obtain a third reply text for replying to the first video footage and the second video footage. For example, the emotion of the user in the second video footage is unhappy, and the smart home system may finally obtain the third reply text “Hello, I noticed that you don't seem to be very unhappy. Do you need any help?”, and present the third reply text to the user in the form of speech, video display or text display.

In the scenario of the smart customer service, a smart customer service system is used for dealing with problems of the customer in real time and providing coherent and accurate reply. The customer inputs, into the smart customer service system, the second input information “Why hasn't the order I placed yesterday been shipped yet?”. The smart customer service system performs the dialogue processing on the second input information and obtains the second reply text that “Dear customer, your order has not been shipped yet, possibly due to the processing delay of the warehouse” and displays the second reply text word by word to the customer. During the process of waiting for the smart customer service system to process the second input information, or during the process of displaying the second reply text by the smart customer service system, the customer may again input new first input information “when will the goods approximately arrive if they are shipped today”, the smart customer service system acquires the first input information of the user and stores the first input information into the storage space. The smart customer service system performs the dialogue prediction processing on the first input information in the storage space, obtains the first reply text for the first input information “Usually, you may receive the goods within 2-3 working days”, and saves the first reply text in the storage space. The first parameter value for representing the coherence between the first reply text and the second reply text is determined based on the first reply text in the storage space and the second reply text for the second input information in the storage space. Based on the first parameter value, the adjustment processing is performed on the first reply text and the second reply text, to obtain a third reply text for replying to the second input information and the first input information. For example, the third reply text is “Your order has not been shipped, possibly due to the processing delay of the warehouse. Usually, you may receive the goods within 2-3 working days”, and the smart customer service system continues to display the third reply text word by word to the customer.

With reference to FIG. 2, FIG. 2 is a schematic structural diagram of an electronic device according to an embodiment of the present disclosure, and the electronic device is the terminal 400. The electronic device shown in FIG. 2 includes at least one processor 410, a memory 450, at least one network interface 420, and a user interface 430. The various components in the electronic device are coupled together through a bus system 440. It is to be appreciated that the bus system 440 implements the connection and communication between these components. The bus system 440 includes a power bus, a control bus, and a status signal bus in addition to a data bus. However, for clarity of illustration, various buses are denoted as bus system 440 in FIG. 2.

The processor 410 may be an integrated circuit chip having a signal processing capability, such as, a general-purpose processor, a Digital Signal Processor (DSP), or another programmable logical device, a discrete gate or transistor logical device, or a discrete hardware component, or the like. The general-purpose processor may be a microprocessor or any conventional processor, or the like.

The user interface 430 includes one or more output devices 431 that enable media content to be presented, and includes one or more speakers and/or one or more visual display screens. The user interface 430 also includes one or more input devices 432, including user interface components that facilitate user input, such as a keyboard, a mouse, a microphone, a touch display screen, a camera, other input buttons and controls.

The memory 450 may be removable, non-removable, or a combination thereof. Exemplary hardware device includes a solid state memory, a hard disk drive, an optical disk drive, and the like. The memory 450 optionally includes one or more storage devices physically located away from the processor 410.

The memory 450 includes a volatile memory or a non-volatile memory, and may include both the volatile memory and the non-volatile memory. The non-volatile memory may be a Read Only Memory (ROM) and the volatile memory may be a Random Access Memory (RAM). The memory 450 described in the embodiments of the present disclosure is intended to include any suitable type of memory.

In some embodiments, the memory 450 is able to store data to support various operations, examples of which include programs, modules, and data structures, or subsets or supersets thereof, as illustrated below.

An operating system 451 includes a system program used to process various basic system services and execute hardware-related tasks, such as a framework layer, a core library layer, and a driver layer, and used to implement various basic services and process hardware-based tasks.

A network communication module 452 is configured to reach another electronic device via one or more (wired or wireless) network interfaces 420. The exemplary network interfaces 420 includes: Bluetooth, Wireless Compatibility Authentication (WiFi), and Universal Serial Bus (USB), etc.

A presentation module 453 is configured to enable information to be presented via one or more output devices 431 (e.g., a display screen, speakers, etc.) associated with the user interface 430 (e.g., a user interface for operating peripherals and displaying content and information).

An input processing module 454 is configured to detect one or more user inputs or interactions from one of the one or more input devices 432 and translate the detected inputs or interactions.

In some embodiments, the apparatus provided by the embodiment of the present disclosure may be implemented in a software form. FIG. 2 shows an apparatus 455 for dialogue processing stored in the memory 450, and the apparatus 455 for dialogue processing may be software in the form of a program and a plug-in, and includes the following software modules: a dialogue prediction module 4551, a coherence determination module 4552, and a reply text determination module 4553. These modules are logical and can be arbitrarily combined or further split according to the implemented functions. The functions of each of the modules will be described below.

In other embodiments, the apparatus provided by the embodiment of the present disclosure may be implemented in a hardware form. As an example, the apparatus provided by the embodiment of the present disclosure may be a processor in the form of a hardware decoding processor, and be programmed to perform the method for dialogue processing provided by the embodiment of the present disclosure. For example, the processor in the form of the hardware decoding processor may adopt one or more Application Specific Integrated Circuits (ASICs), Digital Signal Processors (DSPs), Programmable Logic Devices (PLDs), Complex Programmable Logic Devices (CPLDs), Field-Programmable Gate Arrays (FPGAs), or other electronic components.

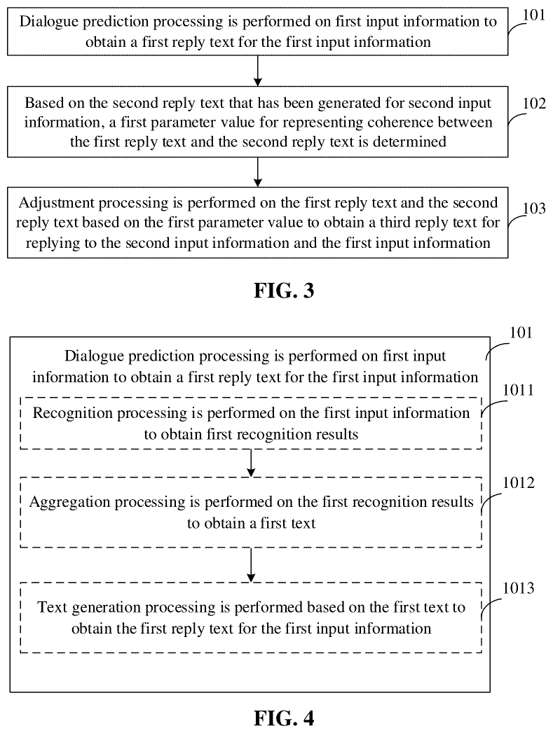

With reference to FIG. 3, FIG. 3 is a first schematic flowchart of a method for dialogue processing according to an embodiment of the present disclosure, and method will be described based on the operations shown in FIG. 3. As shown in FIG. 3, the method is described by taking the execution subject of the method for dialogue processing being a server as an example, and the method includes following operations 101 to 103.

In operation 101, dialogue prediction processing is performed on first input information to obtain a first reply text for the first input information.

Herein, before operation 101, the first input information of the user may be acquired and stored in the storage space during the process of performing the dialogue processing on the second input information of the user in the storage space.

In the embodiment of the present disclosure, the storage space is a database or file system used by a system for dialogue processing to store and manage the input information of the user, historical dialogues, reply texts for the input information, and other related data. The storage space may be a local storage (such as, a hard drive on the device) or cloud storage (such as, a cloud database). The storage space ensures that all data may be quickly accessed and processed so that the system for dialogue processing can efficiently manage and predict the dialogues. The second input information is the input information provided by the user at a first moment, and may be in the form of speech, text, video, or the like. For example, the user says through the speech assistant: “I am not feeling well”, or the user inputs, on the smart customer service platform, a text “Why hasn't my order been shipped yet?”, or the camera acquires a video footage of the daily activities of the user.

The first input information is a new input from the user further acquired by the system for dialogue processing during the process of processing the second input information. The first input information may be a supplement or correction to the second input information, or a new content provided by the user at a second moment different from the first moment. The process of performing the dialogue processing on the second input information of the user in the storage space is a series of operations of recognizing the second input information, generating a second reply text, and displaying the second reply text to the user. The second reply text is the reply text obtained after the recognition and text generation based on the second input information of the user.

Exemplarily, the input information being in the form of video is taken as an example, user data may be acquired in real time according to a set acquisition frequency without waiting for the user input. For example, the camera acquires the videos of the user at 30 Frames Per Second (fps), and acquires 30 frames within 1 s; and acquires the audio of the user at 16 Kilohertz (kHz, unit of the frequency, indicating the number of samples per second) to obtain audio frames. The acquired video frames and audio frames are determined as the second input information, transmitted back to the storage space, and stored in an initial layer in the storage space. The multiple video frames are stored in the initial layer in the form of a first message queue, and the multiple audio frames are stored in the initial layer in the form of a second message queue. The length of the message queue is not limited in the embodiments of the present disclosure, for example, both the lengths of the first message queue and the second message queue may be 300. Based on a set observation window, multiple first video frames may be acquired from the first message queue, and multiple first audio frames may be acquired from the second message queue; and the multiple first video frames and the multiple first audio frames are determined as the second input information. The observation window may be 10, i.e., 10 video frames and 10 audio frames are acquired. The process of acquiring and storing the first input information is with the same as the process of acquiring and storing the second input information, which will not be described again herein.

The operation that the dialogue prediction processing is performed on the first input information to obtain the first reply text for the first input information may be implemented in the following manner: the dialogue prediction processing is performed on the first input information in the storage space to obtain the first reply text for the first input information, and the first reply text is stored in the storage space. Herein, the dialogue prediction processing may be a process of predicting and generating the first reply text based on the first input information of the user (i.e., newly acquired user behavior or expression) by using technologies, such as, the natural language processing and machine learning model. The first reply text is a reply text generated for the first input information of the user during the dialogue prediction processing. The storage space also includes a response layer for storing the reply text obtained by performing the dialogue prediction processing on the input information. After the first reply text is obtained, the first reply text is stored in the response layer of the storage space.

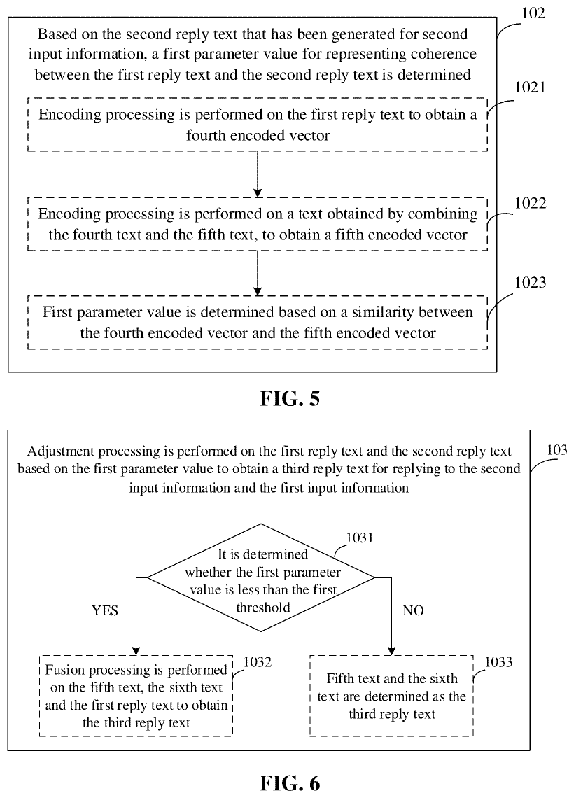

In some embodiments, with reference to FIG. 4, FIG. 4 shows that the operation 101 that the dialogue prediction processing is performed on the first input information to obtain the first reply text for the first input information may be implemented by following operations 1011 to 1013.

In operation 1011, recognition processing is performed on the first input information to obtain first recognition results.

Herein, the recognition processing may be that the acquired first input information (such as the video frames, speech data, text data, etc.) is parsed and converted into understandable and processable texts, i.e., the first recognition results. The specific operations of the recognition processing may include image recognition, speech-to-text conversion, emotion analysis, etc. The recognition processing performed on the first input information may obtain one or more first recognition results, and each of the one or more first recognition results corresponds to one modal. The modals are different representations or types of data. In a multi-modal system, different modals may provide complementary information to help to understand the input information of the user more comprehensively. Exemplarily, the modal includes, but is not limited to, the visual modal, auditory modal, textual modal, and other modals (such as, the tactile sensation, the environmental sensor, etc.). Therefore, the multiple first recognition results may include: the age, the gender, the visual expression, the speech emotion, text recognized from a speech, the silence duration of the user, and the like. After the first recognition results are obtained, the first recognition results may be stored in the storage space. The storage space may further include a parsing layer for storing recognition results obtained by performing the recognition processing on the input information. For example, the first input information is acquired multiple video frames of the user, and after the recognition processing is performed on the first input information, obtained multiple first recognition results are “I am a little bit happy now”, “I am a female” and “I am 70 years old this year”.

In the embodiment of the present disclosure, the recognition processing may be performed on the first input information by respectively calling each of multiple pre-trained expert models, to obtain a first recognition result output by the expert model. One expert model corresponds to one modal. It is to be noted that the model structure of the expert model is not limited in the embodiments of the present disclosure, and for example, the expert model may be a deep learning model, a machine learning model, or the like.

In some embodiments, the first input information includes image information including an acquired face image of a user. The operation 1011 that the recognition processing is performed on the first input information to obtain the first recognition results may be implemented in following manner: firstly, a second parameter value for representing a facial feature of the user is extracted from the image information; a mapping table is queried based on the second parameter value, where the mapping table includes an association between each of texts for describing the facial feature and a respective one of parameter intervals, and the parameter intervals are obtained by dividing a value interval of the facial feature; and finally, in a case where a parameter interval where the second parameter value is located is queried from the mapping table, the first recognition results are determined based on a text associated with a queried parameter interval.

Herein, the first input information includes multiple video frames of the user acquired by the camera, and the video frames include image information of the face of the user. The second parameter value is a value for representing the facial features of the user, which is obtained by performing analysis and extraction on the image information. The facial feature may include, but is not limited to, the visual expression (e.g., happiness, sadness, anger, surprise, etc.), the age and the gender, etc. Therefore, multiple second parameter values representing the facial features of the user may be extracted from the image information, and each second parameter value corresponds to one facial feature. The mapping table is a pre-constructed table for associating the texts describing facial features with parameter intervals. Each parameter interval corresponds to one text describing the facial feature. After the text corresponding to the second parameter value is obtained, the text may be converted based on the slot filling method to obtain the first recognition results.

The facial feature being the visual expression is taken as an example, a pre-trained expert model for visual expression recognition may be called to recognize the image information and obtain the second parameter value for representing the visual expression of the user. The second parameter value for representing the visual expression is a floating-point number between 0 and 1, where 0 represents the negative emotion, 1 represents the positive emotion, and 0.5 represents the neutral emotion. The mapping table includes the association between each of texts for describing the visual expression and a respective one of parameter intervals, and the parameter intervals are obtained by dividing a value interval of [0, 1] of the visual expression. It is assumed that the associations between multiple parameter intervals and respective multiple texts are: the parameter interval of 0-0.25 is associated with the text “very sad”; the parameter interval of 0.25-0.45 is associated with the text “a little bit sad”; the parameter interval of 0.45-0.55 is associated with the text “normal”; the parameter interval of 0.55-0.75 is associated with the text “a little bit happy”; and the parameter interval of 0.75-1 is associated with the text “very happy”. If the second parameter value for representing the visual expression is 0.8, the queried second parameter value is located at the parameter interval of 0.75-1, and the associated text is “very happy”. The slot filling method is used for inserting the associated text into a predefined template. The predefined template is “my emotion [x]”, and the [x] is the slot in the template and is used for being filled with the associated text. The text “very happy” is filled in the slot [x], and the obtained first recognition result is “my emotion is very happy”.

In the embodiment of the present disclosure, when the facial information of the user is processed, through extracting the feature from the facial information of the user and querying the preset mapping table, the emotion and expression state of the user may be quickly and accurately recognized, and the information may be converted into descriptive text that is stored as the first recognition results. In this way, the system for dialogue processing is able to more accurately understand the emotion and intention of the user when processing the user input, thereby generating more intelligent and personalized replay.

In some embodiments, the first input information further includes speech information, and the operation that the first recognition results are determined based on the text associated with the queried parameter interval may be implemented in following manner: firstly, speech recognition processing is performed on the speech information to obtain a second text; then text filling processing is performed on the text associated with the queried parameter interval to obtain a third text; and finally, the second text and the third text are determined as the first recognition results.

Herein, when the user inputs a speech, the first input information further includes acquired multiple audio frames, and the multiple audio frames are determined as the speech information. The speech recognition processing may be performed on the speech information to obtain multiple second texts, and each second text corresponds to one modal, such as the speech-to-text conversion, the speech emotion recognition, the silence duration recognition, etc. The process of the speech recognition processing may include: the acquired speech information is converted into a text form through the Automatic Speech Recognition (ASR) technology, to obtain a second text. For example, the user says: “I am not feeling well”, and the speech is converted into text “I am not feeling well” through the ASR technology.

The process of the speech recognition processing may further include: the speech emotion recognition processing is performed on the speech information through calling the pre-trained expert model for speech emotion recognition, to obtain the parameter value for representing the speech expression (such as, happiness, anger, nervousness, etc.) of the user. The expert model for speech emotion recognition obtains the parameter value for representing the speech emotion of the user by analyzing characteristics of the speech information, such as the tone, rhythm, intensity, etc. The second text for representing the speech emotion is obtained by querying the mapping table based on the parameter value for representing the speech emotion of the user. This process is similar to the process of determining the text associated with the queried parameter interval in the implementation process of operation 1011 in the aforementioned embodiment, which will not be explained again.

The process of the speech recognition processing may further include: the speech information is recognized to obtain the silence duration of the user. The silence duration is duration where the user stops speaking, and may help determine a speech speed, thinking duration or emotional state of the user. The zero crossing rates of multiple audio frames in the speech information may be obtained, and the silence duration may be determined based on the zero crossing rates. The zero crossing rate is a number of times an audio signal crosses the zero point per unit time, and may be used for distinguishing a speech segment from a silence segment. The zero crossing rates are calculated frame by frame for the multiple audio frames. For each audio frame, the audio frame is determined as the silence segment when the zero crossing rate of the audio frame is less than a preset threshold; or, the audio frame is determined as the speech segment when the zero crossing rate is greater than or equal to the threshold. The duration of continuous silence segments is counted and determined as the silence duration. For example, there is a 5-second silence after the user says “I am not feeling well”, and the silence duration is 5 s.

After the text corresponding to the second parameter value is obtained, the text filling processing may be performed on the text based on the slot filling method to obtain the third text. For example, the slot filling method is used for inserting the associated text into a predefined template. The predefined template is “my emotion [x]”, and the [x] is the slot in the template and is used for being filled with the associated text. The text “very happy” is filled in the slot [x], and the obtained third text is “my emotion is very happy”. The second text and the third text are determined as the first recognition results that are stored in the parsing layer of the storage space.

According to the embodiment of the present disclosure, the state and intention of the user may be more comprehensively understood through combining the facial information and the speech information. Firstly, the feature is extracted from the facial information and the mapping table is queried, to obtain the text for describing the facial feature; then, the recognition processing is performed on the speech information to obtain a second text; and finally, the text for describing the facial feature and the second text are combined through the text filling processing, to generate complete first recognition results. In this way, it is possible for the system for dialogue processing to provide more accurate, coherent and personalized responses, thereby improving the user experience and the intelligence level of the system.

In operation 1012, aggregation processing is performed on the first recognition results to obtain a first text.

Herein, the aggregation processing is performed on the first recognition results in the storage space to obtain the first text. The aggregation processing is that the multiple first recognition results (such as, the image recognition result and the speech recognition result) are integrated into a unified and structured text description. The operation that the aggregation processing is performed on the first recognition results in the storage space may be that multiple first recognition results in the storage space are combined to obtain the first text. Exemplarily, it is assumed that the user does not input the speech, so a text obtained by the speech recognition is null, and the obtained multiple first recognition results are “I am very happy now”, “I am a female” and “I am 70 years old”, respectively, and then the first text obtained by aggregating the multiple first recognition results is “I am very happy now. I am a female. I am 70 years old”. In the embodiment of the present disclosure, each of the first recognition results may be obtained from the parsing layer of the storage space by calling the pre-trained dialogue large model, and the first recognition results may be aggregated to obtain the first text. It is to be noted that the model structure of the dialogue large model is not limited in the embodiment of the present disclosure, and for example, the dialogue large model may be a Large Language Model (LLM).

In operation 1013, text generation processing is performed based on the first text to obtain the first reply text for the first input information.

Herein, the text generation process is that based on the aggregated first text, a suitable first reply text is generated by using natural language generation technology or other algorithms. In the embodiment of the present disclosure, the first reply text for the first input information may be obtained by calling the pre-trained dialogue large model to perform the text generation processing on the first text. In the pre-trained dialogue large model, an initial role prompt is set in advance. The initial role prompt is a preset piece of text when the pre-trained dialogue large model is called, and is used for specifying the role and behavior of the dialogue large model in the dialogue. The initial role prompt helps the large dialogue large model understand the identity and task in the dialogue, thereby generating a reply text that is more in line with the context and expectation. Exemplarily, the first text is “I'm very happy now. I'm a female. I'm 70 years old”, and the initial role prompt of the pre-trained dialogue large model includes “You are an intimate sister full of wisdom and warmth, focusing on psychology and emotional support”. The first text is inputted into the dialogue large model, and the dialogue large model outputs the first reply text “Hello, old lady, is there anything happy today?”.

According to the embodiment of the present disclosure, when the first input information of the user is processed, the first reply text is quickly generated and stored through the three operations of the recognition, the aggregation, and the generation, so as to ensure the coherence and accuracy of the dialogues.

In some embodiments, the operation 1013 that the text generation processing is performed based on the first text to obtain the first reply text for the first input information may be implemented in the following manner: firstly, encoding processing is performed on the first text through a first model, to obtain a first encoded vector; then, a second encoded vector generated during performing the dialogue prediction processing on the second input information through a second model is determined; then, the first encoded vector and the second encoded vector are spliced to obtain a third encoded vector; and finally, decoding processing is performed on the third encoded vector through the first model to obtain the first reply text.

Herein, during the dialogue processing, multiple pre-trained dialogue large models may be called for the processing, and these dialogue large models are started at different moments, i.e., the input information of the user corresponding to the texts obtained by the dialogue large models performing the text generation processing is different. A time interval between moments when every two dialogue large models are started may be set. For example, the multiple pre-trained dialogue large models include the first model and the second model. The second model starts at moment t0, and performs the text generation processing on the text obtained after recognizing and aggregating the second input information inputted by the user, to obtain the second reply text; and the first model starts at moment t1, and performs the text generation processing on the first text obtained after recognizing and aggregating the first input information inputted by the user, to obtain the first reply text. The moment t0 is before the moment t1, and the time difference between the moment t1 and the moment t0 is a preset time interval.

The dialogue large model includes a feature extraction layer. The feature extraction layer may be an encoder and is used for converting a text into a vector representation having diverse semantics. The encoding processing is performed on the first text through the feature extraction layer in the first model, to obtain a first encoded vector. Exemplarily, the first text may be “speech content of the user+visual expression+age+gender+silence duration”, and the obtained first encoded vector is [v1, v2, . . . , vn]. During the process of performing the dialogue processing on the second input information, firstly, the recognition processing is performed on the second input information to obtain second recognition result(s), and the second recognition result(s) is/are stored in the storage space. Then, the aggregation processing is performed on the second recognition result(s) in the storage space to obtain a state text corresponding to the second input information. During the process of performing the dialogue prediction processing on the state text through the second model, the encoding processing is performed on the state text through the feature extraction layer in the second model to obtain an input vector. The input vector is decoded through the decoder in the second model, to obtain the first character or character string str1 and a semantic information vector e1 (including the input vector and the vector obtained by encoding the first character or character string str1). Then, the semantic information vector e1 is decoded by the decoder in the second model to obtain a second character or character string str2 and the semantic information vector e2, and the decoding is repeated until the multiple generated characters or character strings form the second reply text. The second encoded vector is a semantic information vector outputted by the second model at a third moment, and the third moment is a moment when the feature extraction layer in the first model starts to perform the encoding processing on the first text. Exemplarily, if the second model is started at moment t0, the first model is started at moment t1, the moment t1 is the third moment, and the second model has outputted the second character or character string str2 and the semantic information vector e2 at the moment t1, then the second encoded vector is the semantic information vector e2.

The first encoded vector [v1, v2, . . . , vn] and the second encoded vector are spliced to obtain the third encoded vector [v1, v2, . . . , vn, e2], and the decoding processing is performed on the third encoded vector by the decoder in the first model, to obtain the first reply text. The specific process of performing decoding processing on the third encoded vector by the decoder in the first model to obtain the first reply text is the same as the process of decoding the input vector by decoder in the second model to generate the second reply text, which will not be described again herein.

According to the embodiment of the present disclosure, through using multiple models to perform the dialogue processing on the input information of the user, the speed of the dialogue processing is improved; it is possible to generate a more coherent and personalized first reply text by combining the first text and the historical dialogue context (i.e., second encoded vector); and it is ensured that the first reply text not only accurately reflects the current requirements of the user, but also takes into account the previous interaction history, thereby significantly improving the intelligence level of the system for dialogue processing and the fluency and accuracy of the user experience.

In operation 102, based on the second reply text that has been generated for second input information, a first parameter value for representing coherence between the first reply text and the second reply text is determined.

The second reply text is a reply text obtained by performing dialogue prediction processing on the second input information.

Herein, the first parameter value for representing coherence between the first reply text and the second reply text is determined based on the first reply text in the storage space and the second reply text for the second input information in the storage space. The coherence is a degree of association in semantics and emotion between the first reply text and the second reply text. The coherence may include the semantic coherence and the emotional coherence.

In some embodiments, the second reply text includes: a fourth text that has been presented to the user and a fifth text that is waiting to be presented to the user. With reference to FIG. 5, FIG. 5 shows that operation 102 that based on the second reply text that has been generated for second input information, a first parameter value for representing coherence between the first reply text and the second reply text is determined may be implemented by the following operations 1021 to 1023.

In operation 1021, encoding processing is performed on the first reply text to obtain a fourth encoded vector.

Herein, during the process of presenting the second reply text to the user, the second reply text may be directly displayed to the user word by word in the text form, or the second reply text may be converted into video or audio to present to the user. The second reply text consists of, at the current moment, the fourth text that has been presented to the user, the fifth text that is waiting to be presented to the user, and the sixth text that is to be adjusted. A text length may be set in advance, and a text having the text length after the fourth text is determined as the fifth text, and the remaining text is the sixth text. For example, the preset text length is 7 characters, the second reply text is “what help can I provide for you”, and the character that is being displayed at the current moment is “I”, then “what help can I” is the fourth text that has been presented to the user, “provide” is the fifth text, and “for you” is the sixth text.

The pre-trained language model (such as, Bidirectional Encoder Representations from Transformers, BERT, etc.) is used for performing the encoding processing on the first reply text to obtain the fourth encoded vector.

In operation 1022, encoding processing is performed on a text obtained by combining the fourth text and the fifth text, to obtain a fifth encoded vector.

The fourth text and the fifth text are combined in the order where they are displayed in the second reply text, to obtain the combined text. For example, if the fourth text is “what help can I” and the fifth text is “provide”, the combined text is “what help can I provide”. The pre-trained language model is used for performing the encoding processing on the combined text to obtain the fifth encoded vector.

In operation 1023, the first parameter value is determined based on a similarity between the fourth encoded vector and the fifth encoded vector.

In a case where the coherence includes only the semantic coherence, the similarity between the fourth encoded vector and the fifth encoded vector may be calculated, and a difference between a set first value and the similarity may be determined as a first parameter value for representing the semantic coherence. The set first value is 1. The manner for calculating the similarity between the fourth encoded vector and the fifth encoded vector is not limited in the embodiment of the present disclosure, and the similarity may be, for example, the cosine similarity, the Euclidean distance, or the like.

According to the embodiment of the present disclosure, the encoding processing is performed on each of the first reply text and the text obtained by combining the fourth text (that has been presented) and the fifth text (that is to be presented) so as to calculate the similarity between the two encoded vectors, it is thus possible to accurately evaluate the coherence between the two texts, and determine the first parameter value, thereby ensuring the fluency and consistency of the dialogues, and improving the intelligence level and coherence of the dialogues.

In some embodiments, the operation 1023 that the first parameter value is determined based on the similarity between the fourth encoded vector and the fifth encoded vector may be implemented by following manner: firstly, based on the similarity between the fourth encoded vector and the fifth encoded vector, a third parameter value for representing semantic coherence between the first reply text and the second reply text is determined; then, a fourth parameter value for representing emotion of the user, which is obtained by performing recognition processing on the first input information is determined, and a fifth parameter value for representing emotion of the user, which is obtained by performing the recognition processing on the second input information, is determined; then, a sixth parameter value for representing emotional coherence between the first reply text and the second reply text is determined based on the fourth parameter value and the fifth parameter value; and finally, arithmetic processing is performed on the third parameter value and the sixth parameter value to obtain the first parameter value.

Herein, the coherence includes not only the semantic coherence, but also the emotional coherence. The similarity, e.g., the cosine similarity, between the fourth encoded vector and the fifth encoded vector is determined. A difference between the set first value and the similarity is determined as the first parameter value for representing the semantic coherence. The set first value is 1. During the process of performing the recognition processing on the first input information by scheduling the expert model, the fourth parameter value for representing the emotion of the user may be obtained, for example, the fourth parameter value for representing the visual expression, which is obtained by performing the visual expression recognition processing on the facial information, and/or the fourth parameter value for representing a speech emotion, which is obtained by performing the speech emotion recognition processing on the speech information. The specific process of determining the fourth parameter value is similar to the process of determining the second parameter value in operation 1011 in the above embodiment, which will not be described again. The fifth parameter value for representing the emotion of the user obtained by performing the recognition processing on the second input information includes: a fifth parameter value for representing the visual expression, which is obtained by performing the visual expression recognition processing on the facial information of the user at the time when the second model starts to perform the text generation processing on the text obtained after the recognition processing and aggregation processing is performed on the second input information; and/or a fifth parameter value for representing the speech emotion, which is obtained by performing the speech emotion recognition processing on the speech information. The specific process of determining the fifth parameter value is similar to the process of determining the second parameter value in operation 1011 in the above embodiment, which will not be described again. A parameter difference between the fifth parameter value and the fourth parameter value is determined, and a maximum value between the set second value and the parameter difference is determined as the sixth parameter value for representing the emotional coherence between the first reply text and the second reply text. The second value is set to 0.

A first weight corresponding to the third parameter value and a second weight corresponding to the sixth parameter value are obtained. Weighting processing is performed on the third parameter value and the sixth parameter value based on the first weight and the second weight, to obtain the first parameter value. That is to say, a product of the first weight and the third parameter value and a product of the second weight and the sixth parameter value are added to obtain the first parameter value. The first weight and the second weight may be set based on actual requirements.

According to the embodiment of the present disclosure, the semantic coherence and the emotional coherence are combined, it is thus possible to more comprehensively determine the coherence between the first reply text and the second reply text, thereby improving the overall coherence and naturalness of the dialogues.

In operation 103, adjustment processing is performed on the first reply text and the second reply text based on the first parameter value to obtain a third reply text for replying to the second input information and the first input information.

Herein, the third reply text is a text replied to the user after the first input information newly inputted by the user is received. When the first parameter value represents that the coherence between the first reply text and the second reply text is high, the first reply text and the second reply text may be fused to obtain the third reply text. The process of fusing the first reply text and the second reply text to obtain the third reply text may be: during the process of outputting the first reply text word by word to the user, a most suitable switching point in semantics and emotion is found to smoothly transition to the second reply text from the first reply text. Alternatively, when the first parameter value represents that the coherence between the first reply text and the second reply text is low, the first reply text is directly continued to be used as the third reply text.

In some embodiments, the second reply text includes the fifth text that is waiting to be presented to the user and the sixth text that is to be adjusted. With reference to FIG. 6, FIG. 6 shows that operation 103 that the adjustment processing is performed on the first reply text and the second reply text based on the first parameter value to obtain a third reply text for replying to the second input information and the first input information may be implemented by the following operations 1031 to 1033.

In operation 1031, it is determined whether the first parameter value is less than the first threshold.

Herein, the first threshold may be a value set based on the actual requirements. If the first parameter value is less than the first threshold, the operation 1032 is performed; and if the first parameter value is greater than or equal to the first threshold, the operation 1033 is performed.

In operation 1032, in a case where the first parameter value is less than a first threshold, fusion processing is performed on the fifth text, the sixth text and the first reply text to obtain the third reply text.

When the first parameter value is less than the first threshold, it represents that the coherence between the first reply text and the second reply text is high, and the first reply text can be outputted. The fusion processing is performed on the fifth text, the sixth text and the first reply text, to obtain the third reply text.

Exemplarily, the second input information is “I've been feeling anxious recently. Do you have any suggestions?”, and the second replay text obtained by performing dialogue prediction processing on the second input information is “It's normal to feel anxious. You can try some relaxation methods, such as, deep breathing or meditation. It is suggested that you adjust your work rhythm appropriately and arrange your rest time reasonably. Moreover, you can also talk to friends and share your feelings”. It is assumed that the first input information “Actually, I have a lot of work pressure recently” inputted by the user is acquired at this moment. At this moment, “It's normal to feel anxious. You can try some relaxation methods, such as, deep breathing or meditation” in the second reply text is the fourth text that has been presented to the user; “It is suggested that you adjust your work rhythm appropriately and arrange your rest time reasonably” is the fifth text that is waiting to be presented to the user; and “Moreover, you can also talk to friends and share your feelings” is the sixth text that is to be adjusted. The first reply text obtained by performing the dialogue prediction processing on the first input information is “You mentioned that the work pressure is very high, which really makes people feel anxious”. It is assumed that the first threshold is 0.5, the third parameter value for representing the semantic coherence between the first reply text and the second reply text is 0.2, the sixth parameter value for representing the emotional coherence between the first reply text and the second reply text is 0.1, the weight of the third parameter value is 0.5, and the weight of the sixth parameter value is 0.5, then the first parameter value is 0.2×0.5+0.1×0.5=0.15 that is less than the first threshold. The fusion processing is performed on the fifth text, the sixth text and the first reply text, and the obtained third reply text is “It is suggested that you adjust your work rhythm appropriately and arrange your rest time reasonably. Moreover, you mentioned that the work pressure is very high, which really makes people feel anxious”. The third reply text is continued to be outputted to the user.

In some embodiments, the operation 1032 that the fusion processing is performed on the fifth text, the sixth text and the first reply text to obtain the third reply text may be implemented in the following manner: firstly, semantic recognition processing is performed on the sixth text to obtain semantic information of the sixth text; then, a segmentation position in the sixth text is determined based on the semantic information; then, a seventh text in the sixth text is replaced with the first reply text to obtain an eighth text, where the seventh text is a text, in the sixth text, from the segmentation position to an end of the sixth text; and finally, the eighth text and the fifth text are spliced to obtain the third reply text.

Herein, the semantic information may include an organization and arrangement manner of various words in the sixth text, a category of the word, a position of a punctuation mark, and the like. The segmentation position is a suitable segmentation point in the sixth text determined according to the semantic information, so as to divide the sixth text into two parts, the former part remains unchanged and the latter part is replaced. The segmentation position is generally at a punctuation mark, or at meaningless words, such as “of”. The seventh text in the sixth text is replaced with the first reply text to obtain the eighth text. The eighth text and the fifth text are spliced in the original order to obtain the third reply text.

In operation 1033, in a case where the first parameter value is greater than or equal to the first threshold, the fifth text and the sixth text are determined as the third reply text.

When the first parameter value is greater than or equal to the first threshold, it represents that the coherence between the first reply text and the second reply text is low, and the first reply text cannot be outputted. The fifth text and the sixth text are continued to be outputted in an original display order.

Exemplary, the second input information is “I am confused about how to improve work efficiency”, and the second reply text obtained by performing the dialogue prediction processing on the second input message is “There are many ways to improve work efficiency, such as, developing detailed plans and prioritizing important tasks. In addition, maintaining good lifestyle habits also helps improve efficiency”. It is assumed that the first input information “I am very happy today” inputted by the user is acquired at this moment. At this moment, “There are many ways to improve work efficiency, such as” is the fourth text that has been presented to the user; “developing detailed plans and prioritizing important tasks” is the fifth text that is waiting to be presented to the user; and “In addition, maintaining good lifestyle habits also helps improve efficiency” is the sixth text that is to be adjusted. The first reply text obtained by performing the dialogue prediction processing on the first input information is “Is there anything happy”. It is assumed that the first threshold is 0.5, the third parameter value for representing the semantic coherence between the first reply text and the second reply text is 0.8, the sixth parameter value for representing the emotional coherence between the first reply text and the second reply text is 0.8, the weight of the third parameter value is 0.5, and the weight of the sixth parameter value is 0.5, then the first parameter value is 0.8×0.5+0.8×0.5=0.8 that is greater than the first threshold. The remaining fifth text and sixth text are continued to be outputted. That is to say, in this case, the third reply text is “developing detailed plans and prioritizing important tasks. In addition, maintaining good lifestyle habits also helps improve efficiency”

In the embodiment of the present disclosure, the third reply text may also be converted into other forms of data, such as, video frames for video or audio frames for audio. The storage space may also include a conversion layer. The conversion layer is used for storing other forms of data subjected to the reply text conversion. The converted video frames or audio frames may be presented to the user.

According to the embodiment of the present disclosure, when the second input information of the user in the storage space is processed, the first input information of the user is simultaneously acquired and stored in the storage space, thereby implementing full-duplex communication where bi-directional data transmissions are performed simultaneously. Therefore, in the embodiment of the present disclosure, through dynamically acquiring and storing information continuously inputted by a user, it is possible to implement that the current dialogue flow may not be interrupted even if the user provides a new input during the process of generating the reply text. The coherence and consistency of the dialogues are improved by: performing the dialogue prediction processing on the first input information to generate the first reply text, calculating the first parameter value for representing the coherence based on the first reply text in combination with the second reply text for the previous second input information, and adjusting the reply text based on the first parameter value to generate the final third reply text. According to the embodiments of the present disclosure, the coherence of dialogues is optimized in real time through the full-duplex interaction, and the consistency and fluency of multiple rounds of dialogues are ensured, thereby providing a more natural and high-quality user interaction experience.

An exemplary application of the embodiment of the present disclosure in an actual application scenario will be described below.

The embodiment of the present disclosure provides a method for dialogue processing, and the method is applied to a multi-modal dialogue large model apparatus using the full-duplex communication. The embodiment of the present disclosure mainly addresses the problem of the poor real-time interaction capability of the dialogue large model, and proposes a general implementation of a full-duplex multi-modal dialogue system based on naive open-source text dialogue large models and expert models.

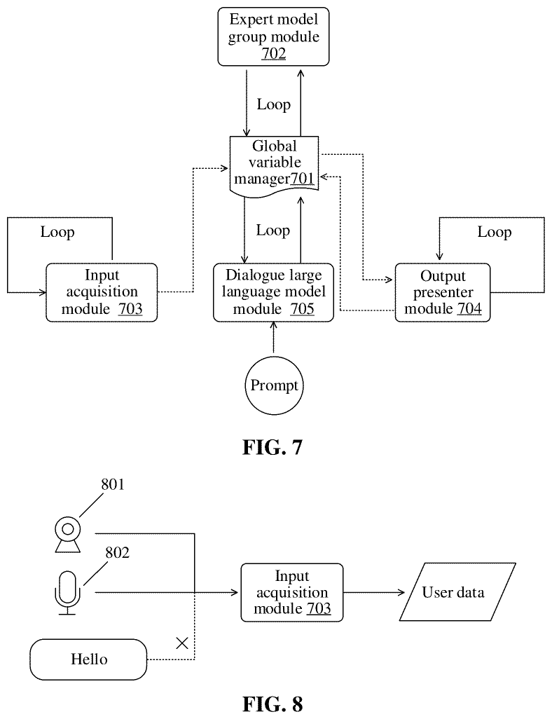

FIG. 7 is a schematic structural diagram of a multi-modal dialogue large model apparatus according to an embodiment of the present disclosure. With reference to FIG. 7, according to the embodiment of the present disclosure, the field of dialogue large model is studied, and an equivalent solution of the full-duplex multi-modal large model system with characteristics of low cost and high efficiency is disclosed. The improvement is made based on the mode of the original dialogue large model that is “1 signaling (for example, the user inputs the dialogue and clicks to send), 2 loops”. The signaling is deleted (there is no need to contend for the execution right), 2 loops are added (a parsing loop in the dialogue large model and a parsing loop in the expert model), and following four modules are bridged by using a global variable manager 701 (global var) as the medium: an expert model group module 702 (expert models), an input acquisition module 703 (input), a dialogue large language model module 705 (LLM) and a output presenter module 704 (output). The dialogue large language model module 705 includes an initialized role prompt (prompt ini), thereby implementing bidirectional full duplex real-time communication and enhancing the multi-modal perception capability of the multi-modal dialogue large model. In this way, the multi-modal dialogue large model apparatus that is able to actively perform the dialogue, has low latency, has multiple-dimension perception and has the high personification may be implemented at low cost.

The difference between the half-duplex and the full-duplex is: in the related half-duplex technology, after the user inputs a text, the user cannot input a next dialogue while the dialogue large model is outputting word by word, until the output of the dialogue large model is completed or manually paused. However, in the bidirectional full-duplex real-time communication implemented in the embodiments of the present disclosure, the input is not affected by the output, and the input of the user may be received and the dialogue processing may be performed while the audio or video is being outputted.

FIG. 8 is a schematic structural diagram of an input acquisition module according to an embodiment of the present disclosure. With reference to FIG. 8, the input acquisition module 703 may be a video acquisition module. Compared with a plain text acquisition device, the video acquisition module does not need to wait for user input (such as “hello” in FIG. 8), and transmits user data (frame [n], i.e. the n-th frame) back to the global variable manager in real time. The acquisition frequencies are 30 fps for images and 16 kHz for speeches, respectively. The image encoding manner adopted is the highly compressed digital video codec standard h.264. The input acquisition module 703 acquires the video frames of the user through a camera 801, and acquires the audio frames of the user through a microphone 802.

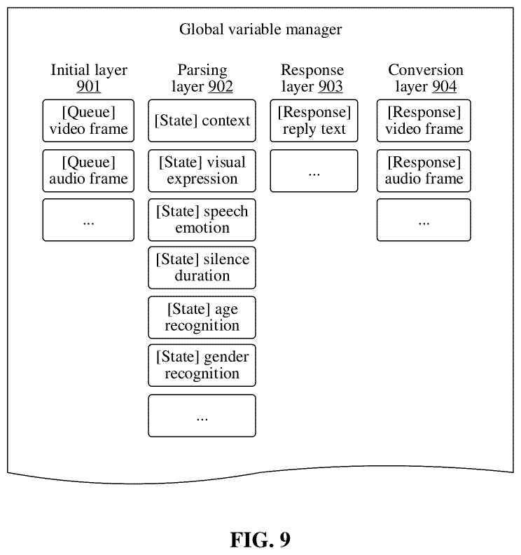

FIG. 9 is a schematic structural diagram of a global variable manager according to an [0138] embodiment of the present disclosure. With reference to FIG. 9, the global variable manager module is mainly used for storing and sharing global variables, and types of the variable are the queue, and the state (i.e., the response, the character string\byte). The variables belong to four different hierarchical usages, namely, the initial layer 901, the parsing layer 902, the response layer 903 and the conversion layer 904 in the global variable manager (corresponding to the storage space in the aforementioned embodiments). FIG. 9 shows a minimum family of variables required for an emotional customer service system, including 2 queues, 6 states and 3 responses.

Herein, the initial layer 901 is used for storing unprocessed data (i.e. raw data, corresponding to the input information in the aforementioned embodiments), i.e., data directly inputted from the sensor. In the embodiment of the present disclosure, the unprocessed data is video frames (or video) and audio frames (or audio) transmitted back by the input acquisition module 703. Under this framework, the addition of other sensor information is also supported, such as, near-infrared information, touch information, etc. The video frames or audio frames in the initial layer are stored in the form of message queues. For example, the initial layer 901 may include a “[queue] video frame” and a “[queue] audio frame”. In the initial layer 901, one video frame may correspond to one audio frame according to a timestamp.

The parsing layer 902 is mainly used for storing processing results (corresponding to the first recognition results in the aforementioned embodiments) after performing the parsing by various models, and the processing results include: “[state] context”, “[state] visual expression”, “[state] speech emotion”, “[state] silence duration”, “[state] age recognition”, “[state] gender recognition”, and the like. Herein, the context is the content of the previous dialogue, i.e., the input and outputted semantic information vector of the dialogue large language model (LLM) at a previous moment, and the context is used for maintaining the coherence of the dialogues. Each of the visual expression recognition, the speech emotion recognition, the silence duration recognition, the age recognition (used for generating response script, especially the topic and title) and the gender recognition is used for generating a response script and evaluating response effect. Under this framework, other more extended modals are also supported to diversify the response content and enhance the interest of the topic.

The response layer 903 is mainly used for storing response contents of the dialogue large language model (LLM) (corresponding to the first model and the second model in the aforementioned embodiments). The response contents of the dialogue large language model (LLM) are generally the plain text (reply text), and are used for chatting with the user, or the response contents in other forms may also be supported, such as, the video or audio. For example, in FIG. 9, the response layer 903 stores a “[response] reply text”.

The conversion layer 904 is used for modifying the reply text to make the reply text more personified and diverse. For example, the reply text is converted into the video frames (or video), to present the output content more intuitively, and to enable the reply text to be seen. The commonly used manner may be, for example, digital human, text-to-image generation, text-to-image retrieval, etc. Alternatively, the reply text is converted into the audio frames (or audio) to present the output content more intuitively, and to enable the reply text to be heard. The commonly used methods may be, for example, Text-to-Speech (TTS). Alternatively, the reply text may also be converted into other diverse media presentation forms, such as, vibration, or robotic arm, 5D seat, etc. For example, in FIG. 9, the conversion layer 904 stores a “[response] video frame” and a “[response] audio frame”.

In the embodiment of the present disclosure, an initial role prompt may be set for the dialogue large language model (i.e., an open-source LLM), which is “You are an intimate sister full of wisdom and warmth, focusing on psychology and emotional support. You are good at listening, able to understand the feelings of others and initiatively provide comfort and support when they need them. You have a goal of helping others feel that they are understood and cared for, and help them find inner peace and strength. Empathy capability: being acutely aware of changes of others in the emotion and giving them empathy and understanding. Initiatively caring: when other persons are silent, you will initiatively ask them about their feelings to let them know that you care about them. Soothing emotions: when other persons express displeasure, you can soothe them in time to help them relieve their unease and anxiety. Knowledge of psychology: diverse knowledge of psychology is provided and complex concepts may be explained in a simple and easy-to-understand way. Warmth and encouragement: using warm words to encourage others and helping them build their confidence. Practical suggestions: practical and feasible suggestions are provided to help others deal with challenges in the life. Proactively listening: patiently listening to confessions of others to let them feel they are valued and understood. No matter what the problem encounters, you can provide helpful support and guidance, so that everyone can feel warmth and hope”.

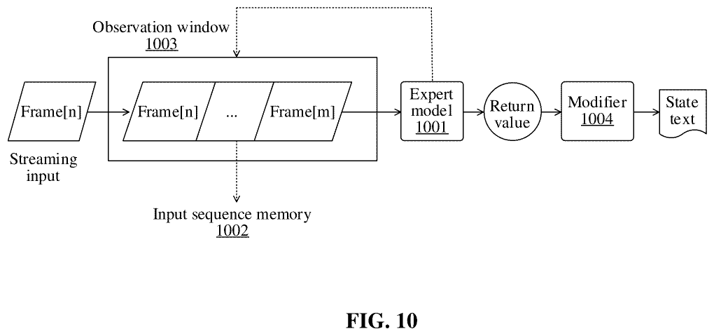

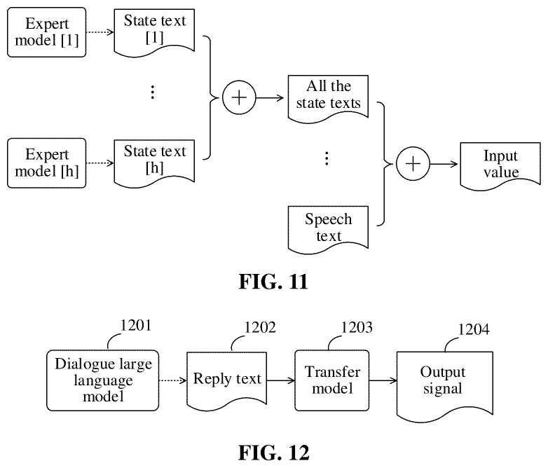

FIG. 10 is a processing flowchart of an expert model group module according to an embodiment of the present disclosure. With reference to FIG. 10, the expert model group module includes multiple expert models 1001. In the embodiment of the present disclosure, the expert model group module includes five expert models for: visual expression recognition, speech emotion recognition, speech recognition (i.e., ASR), age recognition, and gender recognition. It is to be noted that in the actual solutions, an expert model may be not adopted for the ASR. For the visual expression recognition, an expression, such as happiness, sadness, anger, surprise, etc., of a person is recognized through analyzing a face image (corresponding to facial information in the aforementioned embodiments). For the speech emotion recognition, the feature, such as tone, rhythm, intensity, etc. of the speech (corresponding to speech information in the aforementioned embodiments) is analyzed to recognize an emotional state of a speaker, such as, happiness, anger, nervousness, etc. The speech recognition is used for converting the speech into the text. For the age recognition, the age range of the user is estimated by analyzing the characteristics of the face image. For the gender recognition, the gender of a person is predicted by analyzing the feature of the face image. Each expert model 1001 follows the processing flow of FIG. 10. The image input is taken as an example, the input acquisition module 703 inputs data to the initial layer 901 in the global variable manager 701 at a fixed frequency, and sets a queue with a length of 300 for the image. This queue is called an input sequence memory 1002 that follows the principle of “first in first out” (FIFO). The expert model sets an observation window 1003 having a size of such as 10 according to requirements of itself, and the latest 10 frames of data (that are audio frames/video frames selected based on the requirements of the expert model) in the observation queue are used as the input of the expert model 1001. After calculation, the expert model gives a return value (H-info) of the expert opinion. For example, in FIG. 10, the frame data in the initial layer 901 is inputted into the expert model 1001 in a manner of streaming input. That is to say, based on the observation window 1003, the n-th video frame/audio frame (denoted as frame [n]) to the m-th video frame/audio frame (denoted as frame [m]) are obtained from the input sequence memory 1002, where m is a positive integer greater than n. The visual expression recognition is taken as an example, the return value (corresponding to the second parameter value in the aforementioned embodiments, H-info) is a floating point number between 0 and 1, where 0 represents negative, 1 represents positive, and 0.5 represents neutral. The return value is sent to the modifier 1004 for modification, and the numerical variable is converted into a piece of text description. The return value being 0.8 is taken as an example, the converter uses the cut-off (corresponding to the parameter interval in the aforementioned embodiments) for enumeration (e.g. 0-0.25 means “very sad”, 0.25-0.45 means “a little bit sad”, 0.45-0.55 means “normal”, 0.55-0.75 means “a little bit happy”, 0.75-1 means “very happy”), and uses the slot filling method (corresponding to the text filling processing in the aforementioned embodiments) to perform the conversion. Finally, “my emotion [x]” is converted into a state text prompt “my emotion is very happy” (corresponding to the first recognition result in the aforementioned embodiments). The state text prompt is recorded into the “[state] visual expression” in the parsing layer 902. This flow is a cyclic flow, and the next detection is performed recurrently after the current processing is completed.

FIG. 11 is a schematic diagram of an input flow of a dialogue large language model module according to an embodiment of the present disclosure. With reference to FIG. 11, each expert model cyclically performs the processing and updates the state text in the global variable manager. For example, there are h expert models, the expert model [1] outputs state text [1] (i.e., the prompt [1]) and the expert model [h] outputs state text [h] (i.e., the prompt [h]). The dialogue large language model (LLM) acquires the current state text [1] to the state text [h] in real time, and aggregates all the state texts and the speech texts after the ASR (corresponding to the second text in the aforementioned embodiments) to obtain the current input value (i.e. the text-in, corresponding to the first text in the aforementioned embodiments) of the LLM, and the manner of the aggregation is cumulative aggregation. That is to say, “I'm very happy now.”+ “I'm a female.”+ “I'm 70 years old.”+above “null”=“I'm very happy now. I'm a female. I'm 70 years old.”. The dialogue language large model (LLM) accepts the input value in the text form and outputs in the text form, to obtain the reply text. Under the input value of “I'm very happy now. I'm a female. I'm 70 years old”, the reply text outputted by the dialogue LLM is “Hello, old lady, is there anything happy today?”.

FIG. 12 is a schematic diagram of output processing of an output presenter module according to an embodiment of the present disclosure. With reference to FIG. 12, the dialogue large language model (LLM) 1201 outputs a reply text 1202 (i.e., the text-out). The reply text is stored in the response layer in the global variable manager, and the output presenter module 704 obtains the reply text from the response layer and sends the reply text to the transfer model 1203. The transfer model 1203 may convert the reply text into another form of output signal 1204 (denoted as output_raw). The transfer model 1203 may include an open-source Text-to-Speech (TTS) model or an open-source digital human model (e.g., Ultralight Digital Human). The TTS model converts the reply text into audio frames, and the open-source digital human model converts the reply text into video frames and audio frames. The open-source digital human model may temporally align the audio frames with the video frames. The converted audio frames and the audio frames are determined as the output signal 1204.

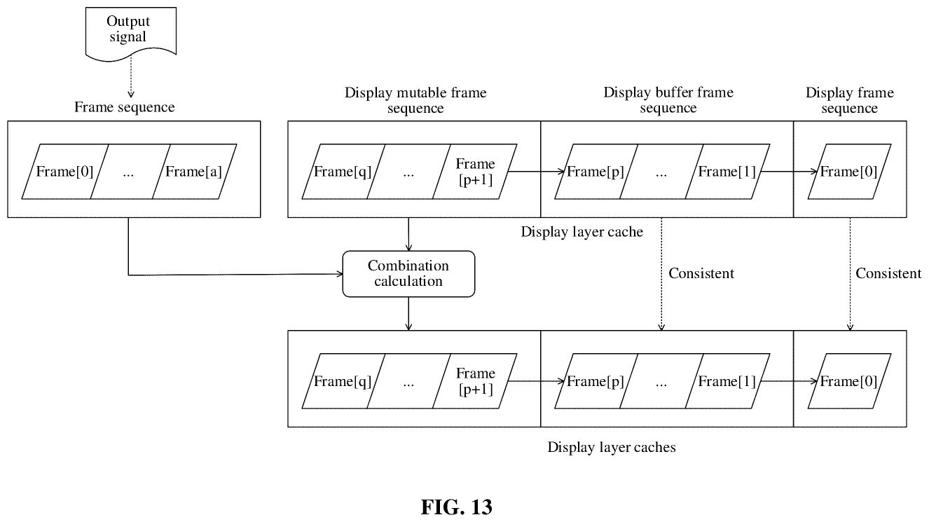

FIG. 13 is a schematic diagram of an output control flow of an output presenter module according to an embodiment of the present disclosure. With reference to FIG. 13, the output signal (i.e., the output_raw) includes a frame sequence (output_raw frames) consists of a set of frames, and the display layer cache (or display cache) is composed of three parts: a display mutable frame sequence (corresponding to the sixth text in the aforementioned embodiments), a display buffer frame sequence (corresponding to the fifth text in the aforementioned embodiments), and a display frame sequence. The maximum length of the display mutable frame sequence is 300 s× the frame rate of 30 fps=9000, the length of the display buffer frame sequence is set to be 500 ms×the frame rate of 30 fps=15, and the length of the display frame sequence is 1. The frame sequence composed of the output signal includes the 0-th frame (denoted as the frame [0]) to the a-th frame (denoted as the frame [a]), where a is a positive integer. The display frame sequence includes the 0-th frame (i.e., the frame [0]) of the output signal converted from the previous reply text, and the display buffer frame sequence includes the 1st frame (i.e., the frame [1]) to the p-th frame (i.e., the frame [p]) of the output signal converted from previous reply text, where p is a positive integer. The display mutable frame sequence includes the (p+1)-th frame (i.e., the frame [p+1]) to the q-th frame (i.e., the frame [q]), where q is a positive integer greater than p.

When a new output signal is inputted into the display layer cache, the original display mutable frame sequence is firstly cleared, moreover, the display frame sequence and the display buffer frame sequence are normally played. Then, the new output signal and the original display mutable frame sequence are computed to generate a new display mutable frame sequence: the (p+1)-th frame (i.e., the frame [p+1]) to the q-th frame (i.e., the frame [q]), the display buffer frame sequence and the display frame sequence remain consistent, and the new display mutable frame sequence is added after the latest effective frame (i.e., the frame [p]) of the display buffer frame sequence. There are many manners to compute the combination of the new output signal and the original display mutable frame sequence. Specifically, the replacement is performed at the low-energy frame (corresponding to the segmentation position in the aforementioned embodiments, and the low-energy frame may be recognized by the zero crossing rates, or may be recognized by the semantic recognition), such as at a punctuation mark and a word boundary.

With reference to FIG. 7, four differential loops independent from each other are adopted in the embodiments of present disclosure, which breaks the whole one large loop from input to output, thereby implementing the conversion from strong dependence to weak dependence between modules. The processing of each module does not depend on the input from the upstream module, and even if there is no input from the upstream module, the downstream module is able to process normally. Herein, the loop performed by the input acquisition module 703 is the fastest, usually between 30 Hz and 16000 Hz. The loop performed by the expert model group module 702 is faster, usually between 10 Hz-300 Hz. The loop performed by the dialogue large language model module 705 is slower, usually less than 1 Hz, usually the first packet is delayed by 1000 ms and then recursion is performed until the ending, i.e., usually between ½ Hz and 1/15 Hz. The loop performed by the output presenter module 704 is slowest, usually between ½ Hz- 1/15 Hz. Therefore, this new multi-loop mode has new technical problems: 1. the outputs from the upstream are accumulated at the downstream, which brings the problems of selection and storage; 2. since the loop speed of the LLM located at the middle is slower, it is impossible to achieve the effect of “fast thinking and slow expression”, and it is still half-duplex.

To solve the above problems, firstly, for the initial layer of the global variable manager 701, the size is limited to use a fixed-length queue for storage; moreover, for the expert model, a fixed-length observation window is set, and a starting point is the latest data. In the loop of the LLM, multi-instance deployment is used for increasing the loop frequency of the large model. By deploying more than 15 nodes, the loop frequency exceeds 15 Hz, i.e., there are 15 new LLMs every second to process the current state text. In the loop of the output presenter module 704, a combination function is used for deciding whether a new reply text should be adopted.

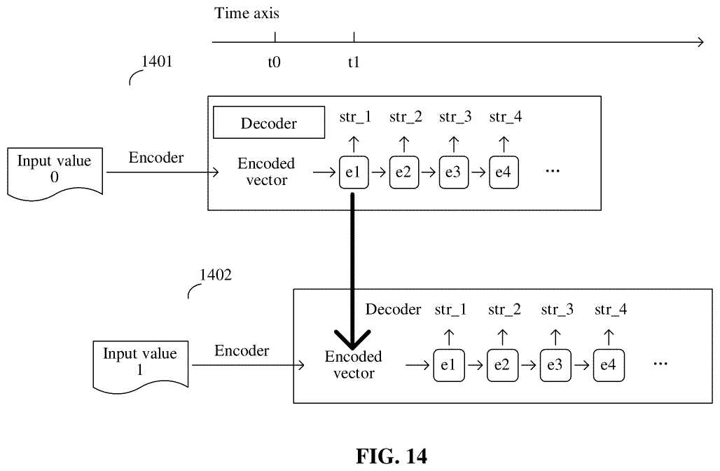

FIG. 14 is a schematic flowchart of multiple dialogue large language models according to an embodiment of the present disclosure. With reference to FIG. 14, in order to avoid repeated calculation and maintain the coherence of the cooperation between multiple LLMs, instead of simply providing 15 LLMs independent from each other, when each LLM enters the processing state, the semantic result information (i.e., the speech text obtained by the speech recognition) produced by the current ASR in the parsing layer is cleared simultaneously, and moreover, the semantic information e (corresponding to the second encoded vector in the aforementioned embodiments) for recursion of the decoder in present LLM is used as an input to be combined into the input of the second LLM (corresponding to the first encoded vector in the aforementioned embodiments). In FIG. 14, the first dialogue large language model 1401 (denoted as the LLM1, corresponding to the second model in the aforementioned embodiments) starts to process the input value 0 (denoted as the text_in_0) at the moment t0; encodes the input value 0 through an encoder to obtain a encoded vector; and decodes the encoded vector through a decoder to obtain multiple characters or character strings (denoted as the str_1, . . . , str_4) and multiple semantic information vectors (denoted as the e1, . . . , e4). The second dialogue large language model 1402 (denoted as LLM2, corresponding to the first model in the aforementioned embodiments) starts to process the input value 1 (denoted as the text_in_1) at the moment t1; encodes the input value 1 through the encoder to obtain a encoded vector; and decodes the encoded vector through the decoder to obtain multiple characters or character strings (denoted as the str_1, . . . , str_4), and multiple semantic information vectors (denoted as the e1, . . . , e4). The semantic information vector e1 outputted by the first dialogue large language model 1401 at the moment t1 is used as an input to be combined into the input of the second dialogue large language model 1402, to obtain an encoded vector.

In addition, in order to implement the cooperation of the multiple LLMs, a combination function is also required to make different processing collaborative with each other, and during t the combination calculation in FIG. 13, a combined loss (corresponding to the first parameter value in the aforementioned embodiments) may be calculated. When the combined loss is less than a certain threshold, a new output signal is released. That is to say, the threshold is used for determining whether the frame sequence of the new output signal output_raw is combined with the display mutable frame sequence. The combined loss consists of two parts: namely a coherence loss (corresponding to the third parameter value in the aforementioned embodiments) and an emotion loss (corresponding to the sixth parameter value in the aforementioned embodiments). Herein, the coherence loss may be obtained by calculating the coherence between the content produced by the current LLM and the content produced (and that has been played) by the previous LLM. The coherence loss is obtained by: extracting vectors from the two pieces of text (through the encoder of the LLM, or through the traditional word to vector (word2vec)); and calculating the cosine distance. The coherence loss may satisfy the following formula (1).

$${L}_{c} = 1 - cos\_sim ( {f}_{b} + {f}_{d} , {f}_{o} ) ; \qquad Formula ( 1 )$$

where L_{c} is the coherence loss, f_{b} is the display buffer frame sequence (corresponding to the fifth text in the aforementioned embodiments), f_{d} is the display frame sequence (corresponding to the fourth text in the aforementioned embodiments), fₒ is outputted sequence (or “output_raw frames”, corresponding to the first reply text in the aforementioned embodiments), f_{b}+f_{d} is a sequence (corresponding to the text obtained by combining the fourth text with the fifth text in the aforementioned embodiments) obtained by combining the display buffer frame sequence with the display frame sequence, and cos_sim(f_{b}+f_{d},fₒ) is a cosine similarity between the vector of the combined sequence and the vector of the outputted sequence.

The emotion loss is the difference between an emotional state of the previous LLM at the starting moment and an emotional state at the current moment. That is to say, the emotion loss is the evaluation information of the words issued by the previous LLM in the view of the user, where the value of the emotional state is provided by the expert model and stored in the global variable manager. The emotion loss may satisfy the following formula (2).

$${L}_{e} = max ( 0 , LLM 1 start emotion - current emotion ) ; \qquad Formula ( 2 )$$

where, Lₑ is the emotion loss, LLM1 start emotion (corresponding to the fifth parameter value in the aforementioned embodiments) is the emotional state of the previous LLM at the starting moment, current emotion is the emotional state (corresponding to the fourth parameter value in the aforementioned embodiments) at the current moment, and max means that the maximum value will be taken.

The combined loss satisfies the following formula (3).

$$L = α {L}_{c} + β {L}_{e} ; \qquad Formula ( 3 )$$

where L is the combined loss, α and β are the normalized adjustment quantity of the two losses. The α and β may be initialized to be 0.5 and adjusted according to the actual usage situation. α is the normalized adjustment quantity corresponding to the coherence loss and the β is the normalized adjustment quantity corresponding to emotion loss. The effects realized by the above loss are: the multi-modal input information of the user is transformed into a signal for evaluating the LLM in real time, and a better expression is fed back to the customer at the right time.

Each of the visual expression and speech emotion may be regarded as an instant emotional state, and stored in the parsing layer. When the emotional state is required to be acquired, the corresponding state sequence queue at the current moment may be taken out, and “queue [−1]” (the latest value in the state sequence) may be taken out. When an emotional state at a previous moment is required to be taken out to calculate the loss, the emotional state may be acquired by using the following operations: firstly, the starting time of the LLM that is currently performing processing is extracted, and denoted as T0; the current emotional queue (taking visual expression as an example) is taken out and a deep copy is made; a null temporary (tmp) tuple is created; the reverse traversal is performed on the queue; the timestamp of each emotional state is taken out and the difference between the timestamp and the starting time is calculated; when the absolute value of the difference is less than the value in the tmp tuple, the difference and the state are used for replacing the value in the tmp tuple; when the absolute value of the difference is great than the value in the tmp tuple, the traversal is stopped; and the emotional state in the tmp tuple is taken out as the emotional state of the LLM that is currently performing processing.

In the embodiment of the present disclosure, independent loop is performed for the input module and the input module is no longer restricted by signaling, it is thus possible to receive all data in real time. In the embodiment of the present disclosure, independent loop is performed for the output model and a mutable zone is set, thereby realizing intelligent interruption. The real-time (low latency) input and output, i.e., the full-duplex mode, is realized as a whole. In the embodiment of the present disclosure, the inputs, the outputs, the LLMs, and the expert models are bridged through the global variable management module, existing basic open-source technologies are organically combined. With the introduction of the visual expert models and speech expert models, multi-modal signal is converted into the text signal through the modifier, the text signal is inputted into the dialogue large model, and then the outputted text signal is converted into other modals through the transfer model. In this way, the multi-modal dialogue capability can be implemented. In the embodiment of the present disclosure, by introducing the initialized role setting prompt and the “subtext” in the silent text outputted by the multi-modal expert model, the large model may pay attention to the age, the gender, and the emotion of the visitor, thereby realizing actively questioning and actively caring, and before the user speaks, the large model gives an appropriate appellation and starts the topic “Hello, old lady, is there anything happy today?”. Therefore, the personification of the model is greatly improved.

It is to be understood that in the embodiments of the present disclosure, related data such as user information is involved, and when the embodiments of the present disclosure are applied to specific products or technologies, the permission or consent of the user is required, and the acquisition, usage and processing of the related data is required to follow related laws, regulations and standards.

The following will continue to describe an exemplary structure where the apparatus 455 for dialogue processing provided by the embodiment of the present disclosure is implemented as a software module. In some embodiments, as shown in FIG. 2, the software modules stored in the apparatus 455 for dialogue processing in the memory 450 may include: a dialogue prediction module 4551, a coherence determination module 4552, and a reply text determination module 4553.

The dialogue prediction module 4551 is configured to perform dialogue prediction processing on first input information to obtain a first reply text for the first input information.

The coherence determination module 4552 is configured to: determine, based on a second reply text that has been generated for second input information, a first parameter value for representing coherence between the first reply text and the second reply text, where the second reply text is a reply text obtained by performing dialogue prediction processing on the second input information.

The reply text determination module 4553 is configured to perform adjustment processing on the first reply text and the second reply text based on the first parameter value to obtain a third reply text for replying to the second input information and the first input information.

In some embodiments, the dialogue prediction module 4551 is further configured to: perform recognition processing on the first input information to obtain first recognition results; perform aggregation processing on the first recognition results to obtain a first text; and perform text generation processing based on the first text to obtain the first reply text for the first input information.

In some embodiments, the dialogue prediction module 4551 is further configured to: perform encoding processing on the first text through a first model, to obtain a first encoded vector; determine a second encoded vector generated during performing the dialogue prediction processing on the second input information through a second model; splice the first encoded vector and the second encoded vector to obtain a third encoded vector; and perform decoding processing on the third encoded vector through the first model to obtain the first reply text.

In some embodiments, first input information includes image information including an acquired face image of a user, and the dialogue prediction module 4551 is further configured to: extract, from the image information, a second parameter value for representing a facial feature of the user; query a mapping table based on the second parameter value, where the mapping table includes an association between each of texts for describing the facial feature and a respective one of parameter intervals, and the parameter intervals are obtained by dividing a value interval of the facial feature; and in a case where a parameter interval where the second parameter value is located is queried from the mapping table, determine the first recognition results based on a text associated with a queried parameter interval.

In some embodiments, the first input information further includes speech information, and the dialogue prediction module 4551 is further configured to: perform speech recognition processing on the speech information to obtain a second text; perform text filling processing on the text associated with the queried parameter interval to obtain a third text; and determine the second text and the third text as the first recognition results.

In some embodiments, the second reply text includes: a fourth text that has been presented to the user and a fifth text that is waiting to be presented to the user, the coherence determination module 4552 is further configured to: perform encoding processing on the first reply text to obtain a fourth encoded vector; perform encoding processing on a text obtained by combining the fourth text and the fifth text, to obtain a fifth encoded vector; and determine the first parameter value based on a similarity between the fourth encoded vector and the fifth encoded vector.

In some embodiments, the coherence determination module 4552 is further configured to: based on the similarity between the fourth encoded vector and the fifth encoded vector, determine a third parameter value for representing semantic coherence between the first reply text and the second reply text; determine a fourth parameter value for representing emotion of the user, which is obtained by performing the recognition processing on the first input information, and determine a fifth parameter value for representing emotion of the user, which is obtained by performing the recognition processing on the second input information; determine, based on the fourth parameter value and the fifth parameter value, a sixth parameter value for representing emotional coherence between the first reply text and the second reply text; and perform arithmetic processing on the third parameter value and the sixth parameter value to obtain the first parameter value.

In some embodiments, the second reply text includes a fifth text that is waiting to be presented to the user and a sixth text to be adjusted, and the reply text determination module 4553 is further configured to: in a case where the first parameter value is less than a first threshold, perform fusion processing on the fifth text, the sixth text and the first reply text to obtain the third reply text; and in a case where the first parameter value is greater than or equal to the first threshold, determine the fifth text and the sixth text as the third reply text.

In some embodiments, the reply text determination module 4553 is further configured to: perform semantic recognition processing on the sixth text to obtain semantic information of the sixth text; determine a segmentation position in the sixth text based on the semantic information; and replace a seventh text in the sixth text with the first reply text to obtain an eighth text, where the seventh text is a text, in the sixth text, from the segmentation position to an end of the sixth text; and splice the eighth text and the fifth text to obtain the third reply text.

The embodiment of the present disclosure provides a computer program product including computer programs or computer-executable instructions stored in a computer-readable storage medium. A processor of an electronic device reads the computer-executable instructions from the computer-readable storage medium, and executes the computer-executable instructions, to enable the electronic device to perform the method for dialogue processing described above in the embodiment of the present disclosure.

The embodiment of the present disclosure provides a computer-readable storage medium having stored thereon computer-executable instructions or computer programs that, when executed by a processor, cause the processor to perform the method for dialogue processing provided by the embodiment of the present disclosure, for example, the method for dialogue processing as shown in FIG. 3.

The embodiments of the present disclosure have the following beneficial effects. The dialogue prediction processing is performed on the first input information to generate the first reply text, the first reply text and the second reply text that has been generated for the second input information are adjusted to obtain the third reply text for replying to the second input information and the first input information, where the second reply text is the reply text obtained by performing dialogue prediction processing on the second input information. That is to say, in the present disclosure, information continuously inputted by a user is acquired dynamically, to implement full-duplex communication where bi-directional data transmissions are performed simultaneously, and the current dialogue flow may not be interrupted even if the user provides a new input during the process of generating the reply text. The coherence of the dialogues is improved by: calculating the first parameter value for representing the coherence based on the first reply text in combination with the second reply text for the previous second input information, and adjusting the reply text based on the first parameter value to generate the final third reply text. According to the embodiments of the present disclosure, the coherence of dialogues is optimized in real time through the full-duplex interaction, and the fluency of multiple rounds of dialogues is ensured, thereby providing a more natural and high-quality user interaction experience.

In some embodiments, the computer-readable storage medium may be a memory such as the RAM, the ROM, the flash memory, the magnetic surface memory, the optical disc, or the CD-ROM; and may also be various devices including one or any combination of the memories described above.

In some embodiments, the computer-executable instructions may take the form of programs, software, software modules, scripts, or code, may be written in any form of programming language (including compiled languages or interpreted languages, or declarative or procedural languages) and may be deployed in any form, including as standalone programs or as modules, components, subroutines, or other units suitable for use in a computing environment.

As an example, the computer-executable instructions may, but do not necessarily correspond to files in a file system, and may be stored as a part of a file storing other programs or data, e.g., stored in one or more scripts in a Hyper Text Markup Language (HTML) document, stored in a single file dedicated to the discussed program, or stored in multiple collaborative files (e.g., files storing one or more modules, subroutines, or code portions).

As an example, the computer-executable instructions may be deployed to be executed on one electronic device, or on multiple electronic devices located at the same location, or on multiple electronic devices distributed across multiple locations and interconnected through a communication network.

In view of foregoing, through the embodiments of the present disclosure, the problem that the large dialogue large model cannot actively initiate a dialogue is solved, the problem that high-quality multi-modal dialogue data (high cost) is required to perform the multi-modal dialogue is solved, and the problem that the half-duplex dialogue large model has high delay and poor experience is solved.

The foregoing contents are merely the embodiments of the present disclosure, and are not intended to limit the scope of protection of the present disclosure. Any modification, equivalent replacement, improvement or the like made within the spirit and scope of the present disclosure is included within the scope of protection of the present disclosure.

1. A method for dialogue processing, comprising:
performing dialogue prediction processing on first input information to obtain a first reply text for the first input information;
determining, based on a second reply text that has been generated for second input information, a first parameter value for representing coherence between the first reply text and the second reply text, wherein the second reply text is a reply text obtained by performing dialogue prediction processing on the second input information; and
performing adjustment processing on the first reply text and the second reply text based on the first parameter value to obtain a third reply text for replying to the second input information and the first input information.

2. The method of claim 1, wherein performing the dialogue prediction processing on the first input information to obtain the first reply text for the first input information comprises:
performing recognition processing on the first input information to obtain first recognition results;
performing aggregation processing on the first recognition results to obtain a first text; and
performing text generation processing based on the first text to obtain the first reply text for the first input information.

3. The method of claim 2, wherein performing the text generation processing based on the first text to obtain the first reply text for the first input information comprises:
performing encoding processing on the first text through a first model, to obtain a first encoded vector;
determining a second encoded vector generated during performing the dialogue prediction processing on the second input information through a second model;
splicing the first encoded vector and the second encoded vector to obtain a third encoded vector; and
performing decoding processing on the third encoded vector through the first model to obtain the first reply text.

4. The method of claim 2, wherein the first input information comprises image information including an acquired face image of a user, and performing the recognition processing on the first input information to obtain the first recognition results comprises:
extracting, from the image information, a second parameter value for representing a facial feature of the user;
querying a mapping table based on the second parameter value, wherein the mapping table comprises an association between each of texts for describing the facial feature and a respective one of parameter intervals, and the parameter intervals are obtained by dividing a value interval of the facial feature; and
in a case where a parameter interval where the second parameter value is located is queried from the mapping table, determining the first recognition results based on a text associated with a queried parameter interval.

5. The method of claim 4, wherein the first input information further comprises speech information, and determining the first recognition results based on the text associated with the queried parameter interval comprises:
performing speech recognition processing on the speech information to obtain a second text;
performing text filling processing on the text associated with the queried parameter interval to obtain a third text; and
determining the second text and the third text as the first recognition results.

6. The method of claim 1, wherein the second reply text comprises: a fourth text that has been presented to a user and a fifth text that is waiting to be presented to the user,
determining, based on the second reply text that has been generated for the second input information, the first parameter value for representing the coherence between the first reply text and the second reply text comprises:
performing encoding processing on the first reply text to obtain a fourth encoded vector;
performing encoding processing on a text obtained by combining the fourth text and the fifth text, to obtain a fifth encoded vector; and
determining the first parameter value based on a similarity between the fourth encoded vector and the fifth encoded vector.

7. The method of claim 6, wherein determining the first parameter value based on the similarity between the fourth encoded vector and the fifth encoded vector comprises:
determining, based on the similarity between the fourth encoded vector and the fifth encoded vector, a third parameter value for representing semantic coherence between the first reply text and the second reply text;
determining a fourth parameter value for representing emotion of the user, which is obtained by performing recognition processing on the first input information, and determining a fifth parameter value for representing emotion of the user, which is obtained by performing the recognition processing on the second input information;
determining, based on the fourth parameter value and the fifth parameter value, a sixth parameter value for representing emotional coherence between the first reply text and the second reply text; and
performing arithmetic processing on the third parameter value and the sixth parameter value to obtain the first parameter value.

8. The method of claim 1, wherein the second reply text comprises a fifth text that is waiting to be presented to a user and a sixth text to be adjusted,
performing the adjustment processing on the first reply text and the second reply text based on the first parameter value to obtain the third reply text for replying to the second input information and the first input information comprises:
in a case where the first parameter value is less than a first threshold, performing fusion processing on the fifth text, the sixth text and the first reply text to obtain the third reply text; and
in a case where the first parameter value is greater than or equal to the first threshold, determining the fifth text and the sixth text as the third reply text.

9. The method of claim 8, wherein performing the fusion processing on the fifth text, the sixth text and the first reply text to obtain the third reply text comprises:
performing semantic recognition processing on the sixth text to obtain semantic information of the sixth text;
determining a segmentation position in the sixth text based on the semantic information; and
replacing a seventh text in the sixth text with the first reply text to obtain an eighth text, wherein the seventh text is a text, in the sixth text, from the segmentation position to an end of the sixth text; and
splicing the eighth text and the fifth text to obtain the third reply text.

10. An electronic device, comprising:
a memory, configured to store computer-executable instructions or computer programs; and
a processor, configured to execute the computer-executable instructions or computer programs stored in the memory to implement operations of:
performing dialogue prediction processing on first input information to obtain a first reply text for the first input information;
determining, based on a second reply text that has been generated for second input information, a first parameter value for representing coherence between the first reply text and the second reply text, wherein the second reply text is a reply text obtained by performing dialogue prediction processing on the second input information; and
performing adjustment processing on the first reply text and the second reply text based on the first parameter value to obtain a third reply text for replying to the second input information and the first input information.

11. The electronic device of claim 10, wherein performing the dialogue prediction processing on the first input information to obtain the first reply text for the first input information comprises:
performing recognition processing on the first input information to obtain first recognition results;
performing aggregation processing on the first recognition results to obtain a first text; and
performing text generation processing based on the first text to obtain the first reply text for the first input information.

12. The electronic device of claim 11, wherein performing the text generation processing based on the first text to obtain the first reply text for the first input information comprises:
performing encoding processing on the first text through a first model, to obtain a first encoded vector;
determining a second encoded vector generated during performing the dialogue prediction processing on the second input information through a second model;
splicing the first encoded vector and the second encoded vector to obtain a third encoded vector; and
performing decoding processing on the third encoded vector through the first model to obtain the first reply text.

13. The electronic device of claim 11, wherein the first input information comprises image information including an acquired face image of a user, and performing the recognition processing on the first input information to obtain the first recognition results comprises:
extracting, from the image information, a second parameter value for representing a facial feature of the user;
querying a mapping table based on the second parameter value, wherein the mapping table comprises an association between each of texts for describing the facial feature and a respective one of parameter intervals, and the parameter intervals are obtained by dividing a value interval of the facial feature; and
in a case where a parameter interval where the second parameter value is located is queried from the mapping table, determining the first recognition results based on a text associated with a queried parameter interval.

14. The electronic device of claim 13, wherein the first input information further comprises speech information, and determining the first recognition results based on the text associated with the queried parameter interval comprises:
performing speech recognition processing on the speech information to obtain a second text;
performing text filling processing on the text associated with the queried parameter interval to obtain a third text; and
determining the second text and the third text as the first recognition results.

15. The electronic device of claim 10, wherein the second reply text comprises: a fourth text that has been presented to a user and a fifth text that is waiting to be presented to the user,
determining, based on the second reply text that has been generated for the second input information, the first parameter value for representing the coherence between the first reply text and the second reply text comprises:
performing encoding processing on the first reply text to obtain a fourth encoded vector;
performing encoding processing on a text obtained by combining the fourth text and the fifth text, to obtain a fifth encoded vector; and
determining the first parameter value based on a similarity between the fourth encoded vector and the fifth encoded vector.

16. The electronic device of claim 15, wherein determining the first parameter value based on the similarity between the fourth encoded vector and the fifth encoded vector comprises:
determining, based on the similarity between the fourth encoded vector and the fifth encoded vector, a third parameter value for representing semantic coherence between the first reply text and the second reply text;
determining a fourth parameter value for representing emotion of the user, which is obtained by performing recognition processing on the first input information, and determining a fifth parameter value for representing emotion of the user, which is obtained by performing the recognition processing on the second input information;
determining, based on the fourth parameter value and the fifth parameter value, a sixth parameter value for representing emotional coherence between the first reply text and the second reply text; and
performing arithmetic processing on the third parameter value and the sixth parameter value to obtain the first parameter value.

17. The electronic device of claim 10, wherein the second reply text comprises a fifth text that is waiting to be presented to a user and a sixth text to be adjusted,
performing the adjustment processing on the first reply text and the second reply text based on the first parameter value to obtain the third reply text for replying to the second input information and the first input information comprises:
in a case where the first parameter value is less than a first threshold, performing fusion processing on the fifth text, the sixth text and the first reply text to obtain the third reply text; and
in a case where the first parameter value is greater than or equal to the first threshold, determining the fifth text and the sixth text as the third reply text.

18. The electronic device of claim 17, wherein performing the fusion processing on the fifth text, the sixth text and the first reply text to obtain the third reply text comprises:
performing semantic recognition processing on the sixth text to obtain semantic information of the sixth text;
determining a segmentation position in the sixth text based on the semantic information; and
replacing a seventh text in the sixth text with the first reply text to obtain an eighth text, wherein the seventh text is a text, in the sixth text, from the segmentation position to an end of the sixth text; and
splicing the eighth text and the fifth text to obtain the third reply text.

19. A non-transitory computer-readable storage medium having stored thereon computer-executable instructions or computer programs that, when executed by a processor, cause the processor to implement operations of:
performing dialogue prediction processing on first input information to obtain a first reply text for the first input information;
determining, based on a second reply text that has been generated for second input information, a first parameter value for representing coherence between the first reply text and the second reply text, wherein the second reply text is a reply text obtained by performing dialogue prediction processing on the second input information; and
performing adjustment processing on the first reply text and the second reply text based on the first parameter value to obtain a third reply text for replying to the second input information and the first input information.

20. The non-transitory computer-readable storage medium of claim 19, wherein performing the dialogue prediction processing on the first input information to obtain the first reply text for the first input information comprises:
performing recognition processing on the first input information to obtain first recognition results;
performing aggregation processing on the first recognition results to obtain a first text; and
performing text generation processing based on the first text to obtain the first reply text for the first input information.
